(19) United States
(12) Patent Application Publication
(10) Pub. No.: US 2010/0269588 A1
(43) Pub. Date: Oct. 28, 2010

(54) DEVICE FOR DYNAMICALLY MEASURING THE IMBALANCE OF THE ROTOR OF A TURBOCHARGER

(75) Inventors: Dieter Thelen, Modautal (DE); Juergen Lehmann, Lautertal (DE)

Correspondence Address: ARENT FOX LLP, 1050 CONNECTICUT AVENUE, N.W., SUITE 400, WASHINGTON, DC, 20036, US

(73) Assignee: SCHENCK ROTEC GMBH

(21) Appl. No.: 12/680,680

(22) PCT Filed: Dec. 2, 2008
(86) PCT No.: PCT/EP08/66574

§ 371 Date: Mar. 29, 2010

(30) Foreign Application Priority Data
Dec. 4, 2007 (DE) 10 2007 058 592.8

(51) Int. Cl. G01M 1/16

(52) U.S. Cl. 73/460

(57) ABSTRACT

A device for the dynamic measurement of the imbalance of a turbo rotor, which is rotatably mounted in a housing portion (6), comprises a carrier device (3), with a spring element, on which the housing portion (6) can be fastened in such a way that it has at least two degrees of freedom for oscillating relative to the carrier device, a turbine housing (4) fastened to the carrier device (3) with a channel, which is configured to supply a drive fluid and for loading the turbo rotor with the drive fluid, a free space being provided between the turbine housing (4) and the housing portion (6), a measurement sensor for detecting the oscillations of the housing portion (6), an automatic coupling mechanism (9) with a movable holder, a connection part which is held ready by the holder and can be moved by the latter up to the housing portion (6) and at least one movable coupling element, by means of which the connection part (10) can be coupled to the housing portion (6), the coupling mechanism (9) being movable into a position, in which the at least one coupling element coupling the connection part (10) to the housing portion (6) can be moved relative to the holder in such a way that the coupled connection part (10) can oscillate unimpeded with the housing portion (6).

The invention relates to a device for the dynamic measurement of the imbalance of a turbo rotor, which has a turbine wheel and a compressor wheel, which are arranged on a shaft which is rotatably mounted in a housing portion, comprising a carrier device, which has at least one spring element, on which the housing portion can be fastened in such a way that it has at least two degrees of freedom for oscillating relative to the carrier device, a turbine housing fastened to the carrier device with a channel, which is configured to supply a drive fluid and for loading the turbo rotor with the drive fluid, a free space being provided between the turbine housing and the housing portion, and at least one measurement sensor arranged on the carrier device for detecting the oscillations of the housing portion.

A device of the type mentioned is known from WO 2007/054445 A1. It is used to measure the imbalance of turbo rotors for exhaust gas-driven turbochargers, wherein, to achieve precision which is as high as possible, only one so-called turbocharger cartridge, which consists of the turbo rotor and a housing portion containing the mounting of the turbo rotor, is inserted into an imbalance measuring device and the imbalance measuring device replaces missing and required housing parts by analogously formed device parts, for example a turbine housing. Consequently, the co-oscillating mass of the resiliently mounted measuring structure can be kept small and negative influences on the imbalance measurement caused by the mass can be reduced. The rotor imbalance is preferably measured at an angular velocity of the turbo rotor substantially corresponding to the normal working velocity, the turbine wheel of the turbo rotor being arranged in a turbine housing of the measuring device and being accelerated to the angular velocity required for measurement by the loading with compressed air. The turbine housing is stationarily arranged on the device and separated by adequately large free spaces from the turbocharger cartridge and the oscillating part of its mounting.

To carry out a measuring run which is meaningful and free of disturbance, it is necessary or expedient to couple connection parts to the housing portion of the turbocharger cartridge. The mounting of the turbo rotor, for example, requires an adequate supply of lubricant as far as possible under conditions such as prevail during normal operation of the turbocharger. Furthermore, it has proven to be advantageous if the compressor wheel is covered by a compressor housing for flow guidance or by a protective hood or for reasons of protection and these should be fastened to the housing portion. The application of such connection parts by hand is awkward and time-consuming.

The invention is based on the object of providing a device of the type mentioned at the outset, which allows automatic connection of a turbocharger cartridge to connection parts.

The object is achieved by the invention disclosed in claim 1. Advantageous developments of the invention are disclosed in claims 2 to 11.

The device according to the invention is characterized by an automatic coupling mechanism with a movable holder, a connection part which is held ready by the holder and can be moved by the latter up to the housing portion, and at least one movable coupling element, by means of which the connection part can be coupled to the housing portion, the coupling mechanism being movable into a position, in which the at least one coupling element coupling the connection part to the housing portion can be moved relative to the holder in such a way that the coupled connection portion can oscillate unimpeded with the housing portion.

By means of the device according to the invention, a connection part, for example a lubricant line for supplying the rotor bearing with lubricant, required with the turbocharger cartridge for the measuring run for imbalance measuring, can be automatically coupled to the housing portion and, conversely, can also be separated again from the housing portion, it being simultaneously ensured that the coupling mechanism in the position determined for the measuring run does not limit the freedom of movement of the coupled connection part, not that of the housing portion, and that imbalance-induced oscillations can develop undisturbed.

In an advantageous configuration of the invention, the coupling element may be a U-shaped spring clip, which can be moved into a clamping position encompassing the housing portion and by means of which the connection part can be pressed against the housing portion with a defined force. This configuration is primarily suitable for the connection of a lubricant line, in which the line is pressed radially with respect to the rotational axis against the connection socket of the housing portion with the aid of the spring clip. Generally, the housing portion forming the bearing housing is provided with a lubricant feed opening and a lubricant discharge opening, the openings being arranged on opposite sides of the housing portion. The U-shaped spring clip according to the invention is suitable here for the simultaneous connection of a lubricant feed line and a lubricant discharge line in that each leg of the spring clip is provided with a correspondingly suitable connection piece.

According to a further proposal of the invention, the coupling of the spring clip may be effected in a simple manner in that the legs of the spring clip are held on the arms of spreading tongs and in that the spreading tongs can be moved by a drive into an open position spreading the legs apart and into a closing position coupling the spring clip to the housing portion, the arms being positionable in the closing position relative to the legs in such a way that the spring clip can follow oscillations of the housing portion unimpeded. The spring clip is then held in the closing position by the spring force pressing on the connection part and the corresponding reaction force on the housing portion.

Holding loops are preferably arranged on the arms of the spreading tongs, which holding loops encompass the legs of the spring clip and have a loop opening which is larger than the encompassed cross-section of the legs. In the closing position of the spreading tongs, the holding loops are positioned in such a way that they no longer rest on the legs of the spring clip.

According to a further advantageous configuration of the invention, at least one closure arranged on the connection part may be provided, as the coupling element, with a locking pin which can be moved by a drive arranged on the holder, the drive being separable from the locking pin when the locking pin is located in the clamping position coupling the connection part. This configuration is advantageous, in particular, for coupling a compressor housing to connect the latter to a flange of the housing portion. In this case, the compressor housing preferably has three closures arranged on its periphery at a regular interval.

The invention will be described in more detail below with the aid of an embodiment/embodiments shown in the drawings, in which:

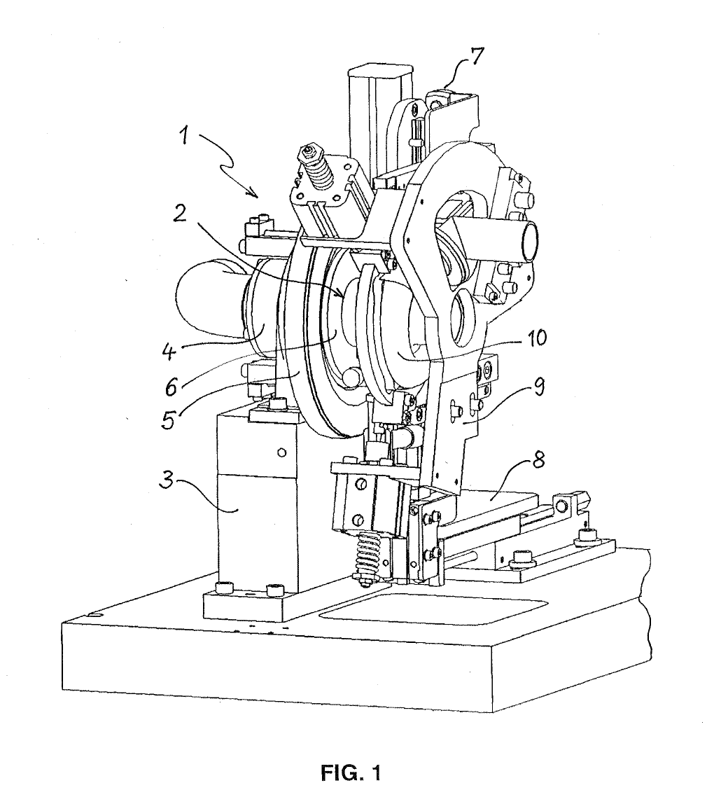

FIG. 1 shows a perspective view of an imbalance measuring device according to the invention,

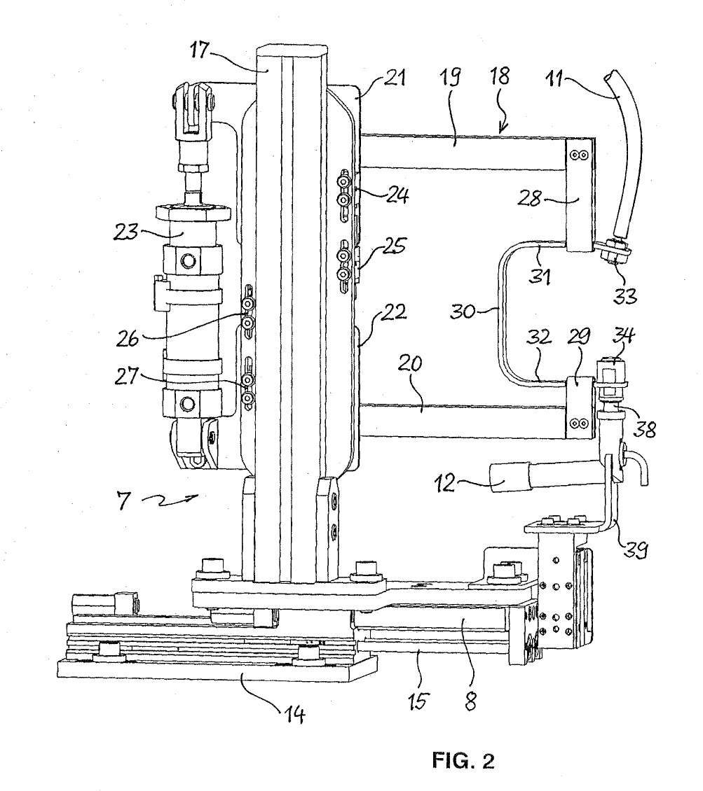

FIG. 2 shows a first view of a first coupling mechanism of the imbalance measuring device according to FIG. 1, intended for coupling feed and discharge lines,

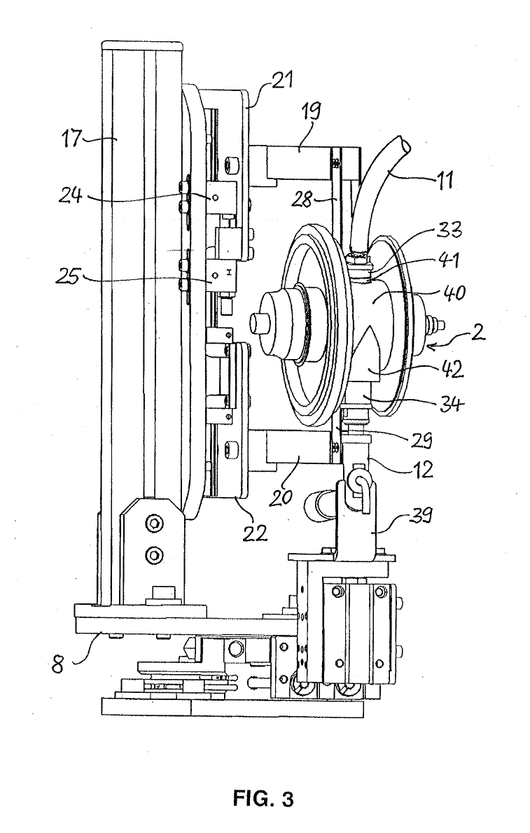

FIG. 3 shows a second view of the coupling mechanism according to FIG. 2,

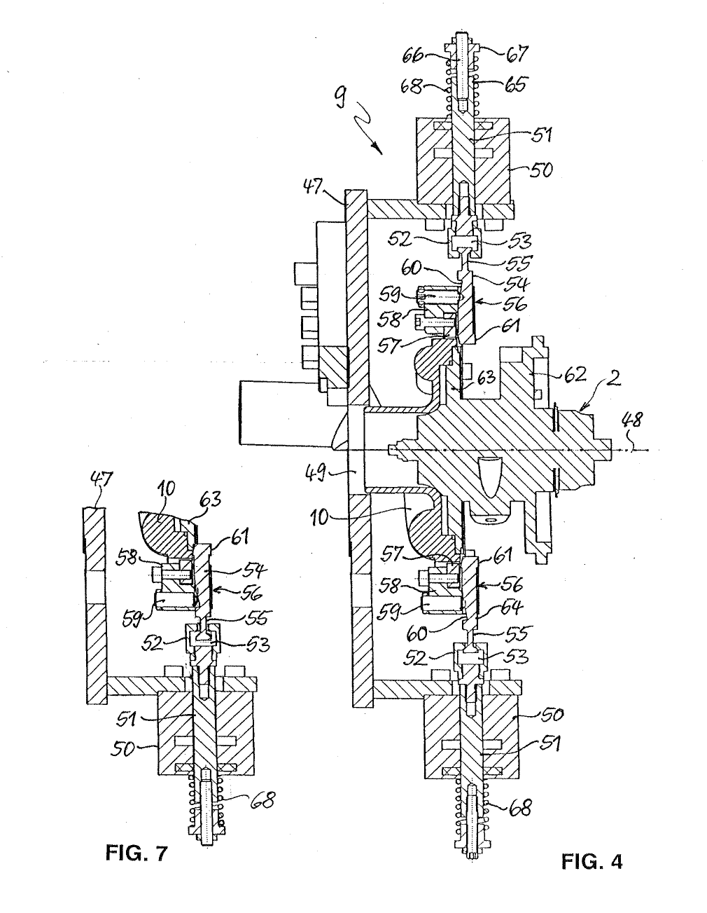

FIG. 4 shows a sectional view of a second coupling mechanism of the imbalance device according to FIG. 1 intended for coupling a compressor housing,

FIG. 5 shows a first perspective view of the coupling mechanism according to FIG. 4,

FIG. 6 shows a second perspective view of the coupling mechanism according to FIG. 4, and

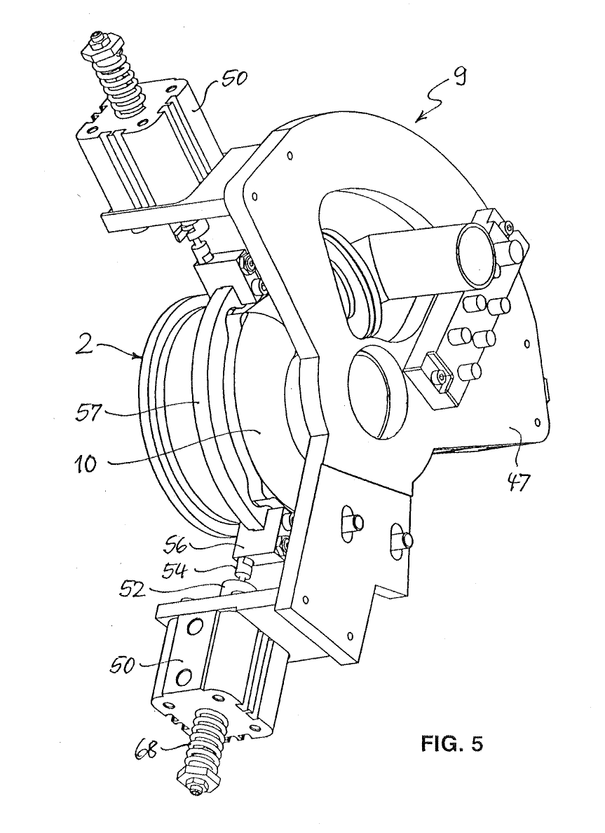

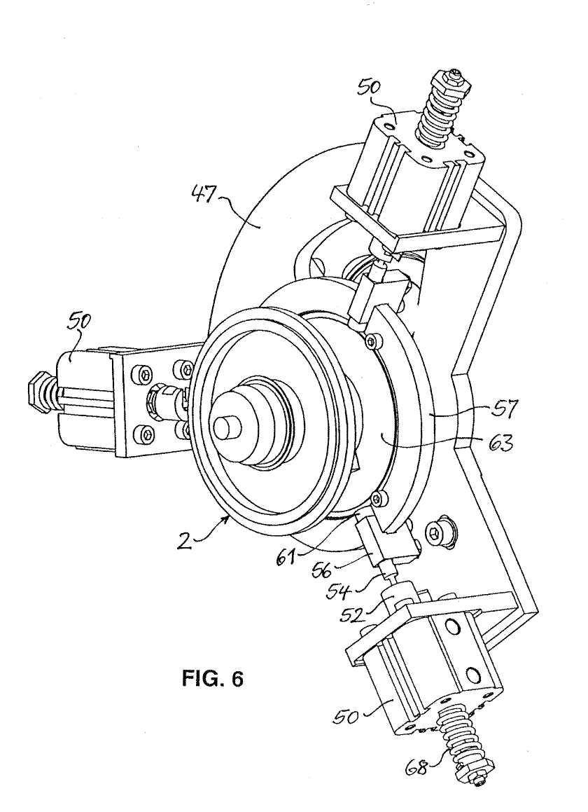

FIG. 7 shows a cut-out of the coupling mechanism according to FIG. 4 in the coupled separation position.

The imbalance measuring device 1 shown in FIG. 1 is intended for measuring the imbalance of the turbo rotor of a turbocharger cartridge 2 and has a turbine housing 4 which is fastened to a rigid stand 3 and can be connected to a compressed air source to drive the turbo rotor. Fastened to the turbine housing 4 by means of spring rods is a clamping device 5 for clamping a housing portion 6, in which the turbo rotor of the turbocharger cartridge 2 is mounted. Arranged on the side of the clamping device 5 remote from the turbine housing 4 is a first coupling mechanism 7, which is used for the automatic coupling of a feed line and a discharge line to the housing portion 6. The coupling mechanism 7 is arranged on a holder 8 which can be moved transversely to the rotational axis of the turbocharger cartridge 2. In addition to the coupling mechanism 7, a second coupling mechanism 9 is shown by means of which a compressor housing 10 can be automatically coupled to the housing portion 6. The coupling mechanism 9 is held in a drive device, not shown, by means of which it can be removed from the turbocharger cartridge 2 in the direction of the rotational axis.

FIGS. 2 and 3 show the first automatic coupling mechanism 7, which is intended for coupling a feedline 11 and a discharge line 12 to a turbocharger cartridge 2. The coupling mechanism 7 has a holder 8 which is held and guided so as to be linearly movable on a guide rail 14. The guide rail 14 is fastened to a stationary part of an imbalance measuring device in a horizontal orientation. Two parallel rods 15, by means of which the holder 8 is connected to a working cylinder, not shown, extend through holes in the guide rail 14. By actuating the working cylinder, the holder 8 can be moved along the guide rail 14.

A tongs carrier 17 of pneumatically actuated spreading tongs 18 is fastened to the holder 8 by means of screws. The spreading tongs 18 have two parallel arms 19, 20, which extend transverse to the tongs carrier 17 and are fastened to holding plates 21, 22, which are longitudinally movably held on the tongs carrier 17. The holding plates 21, 22 are connected to one another by a pneumatic cylinder 23. The mobility of the holding plates 21, 22 is limited in the two movement directions by stop elements 24, 25, 26, 27, which are adjustably fastened to the tongs carrier 17 by means of screws. U-shaped loops 28, 29 which extend at right angles to the arms 19, 20 are fastened to the free ends of the arms 19, 20.

A U-shaped spring clip 30 with legs 31, 32 is hooked into the loops 28, 29. The legs 31, 32 are inserted through the loops 28, 29 and biased in the direction of the ends of the loops 28, 29 and thus hold the spring clip 30 in the position shown in FIG. 1 on the loops 28, 29. Tubular connection elements 33, 34 are fastened to the free ends of the legs 31, 32, which are located on the side of the loops 28, 29 remote from the tongs carrier 17. The connection elements 33, 34 are provided at their mutually facing end faces with a suitable connection profile and sealing elements, to ensure a tight connection to a housing portion 40 of a turbocharger cartridge 2. The connection element 33 is connected to the flexible feed line 11. The connection element 34 projects with a tubular portion 38 into the discharge line 12. The external diameter of the tubular portion 38 is smaller than the internal diameter of the discharge line 12, so a free annular space is present between the two which prevents the connection element 34 coupled to the turbocharger cartridge 2 from striking against the discharge tube if the turbocharger cartridge 2 oscillates during a measuring run. The tube of the discharge line 12 is held by an angle piece 39, which is rigidly connected to the holder 8.

For insertion of a turbocharger cartridge 2 into the imbalance device, the holder 8 is moved with the spreading tongs 8 arranged thereon transversely to the rotational axis of the subsequently inserted turbocharger cartridge 2 into a pulled-back position, so the spreading tongs 18 do not impede the insertion of the turbocharger cartridge 2 into the device. In addition, the pneumatic cylinder 23 is activated to move the arms 19, 20 apart until they rest on the stop elements 24, 27. The spring clip 30 held on the arms 19, 20 is resiliently bent open as a result, the connection elements 33, 34 attaining a spacing which is greater than the external diameter of the housing portion 40 of the turbocharger cartridge 2, in the region of the connection sockets 42, 42 provided for the connection of the feed line and discharge line.

Once the turbocharger cartridge 2 has been inserted in the imbalance measuring device and is firmly clamped in a predetermined position by means of a clamping device, the spring clip 30 is brought, by moving the holder 8 in the direction of the turbocharger cartridge 2, into a position in which it encompasses the turbocharger cartridge 2 in such a way that the connection elements 33, 34 are aligned so as to be coaxial with the connection sockets 41, 42. This position may be determined by an adjustable positioning stop on the guide rail 14 that limits the movement of the holder 8. Alternatively, measuring sensors may also be provided which detect the position of the housing portion 40 relative to the spreading tongs 18. For connecting the connection elements 33, 34, the arms 19, 20 are moved toward one another by activating the pneumatic cylinder 23, the legs 31, 32 being pressed together by the spring force of the spring clip 30 and finally pressing the connection elements 33, 34 against the connection sockets 41, 42 of the housing portion 40. The spring force of the spring clip 30 is in this case of a magnitude such that the spring clip 30 keeps the connection element 33 pressed onto the connection socket 41 in a pressure-tight manner, even against the pressure of the lubricant supplied via the feed line 11. After coupling the spring clip 30 to the housing portion 40, the arms 19, 20 move slightly closer together until they reach their end position on the stop elements 25, 26. As a result, the loops 28, 29 lift off from the legs 31, 32 of the spring clip 30 and produce a free space between the two legs 31, 32 and the insides of the loops 28, 29, so the spring clip 30 can move freely in the openings of the loops 28, 29 when it oscillates together with the turbocharger cartridge 2 during the measuring run. A connection remains between the stationary part of the imbalance measuring device and the spring clip 30 only via the flexible feed line 11. The feed line 11 is, however, adequately flexible and arranged in such a way that the measuring process is not impaired thereby.

FIG. 2 shows the coupling mechanism 7 in the position in which the connection elements 33, 34 are coupled to the turbocharger cartridge 2. The clamping device, by which the turbocharger cartridge 2 is held in the imbalance device, is omitted in FIG. 2 to make the coupling mechanism 7 more visible.

Once the imbalance measurement has been completed, the described process is repeated in the reverse sequence and the spring clip 30 with the connected lines is thus separated and removed from the turbocharger cartridge, so the turbocharger cartridge can be removed unimpeded from the imbalance measuring device.

A coupling mechanism 9 for the automatic coupling of a compressor housing 10 to a turbocharger cartridge 2 is shown in FIGS. 4 to 6. The coupling mechanism 9 has a plate-shaped holder 47, which can be moved back and forth by a drive device, not shown, in the direction of the rotational axis 48 of the turbocharger cartridge 2 between a coupling position set up on the turbocharger cartridge 2 and a charging position remote therefrom. The holder 47 is oriented at right angles to the rotational axis 48 and has an opening 49 which is concentric with the rotational axis 48. Three pneumatic cylinders 50, the piston rods 51 of which are aligned radially with respect to the rotational axis 48, are fastened to the holder 47 on the side facing the turbocharger cartridge 2 at the same spacing from the rotational axis 48 and at a spacing from one another. Fastened at the inner ends facing the rotational axis 48 on the piston rods 51 are gripping sleeves 52, which have an undercut, radially open recess 53. Locking pins 54 are hooked by their actuating ends 55 in the gripping sleeves 52. The actuating ends 55 have a thinner portion which projects from the gripping sleeves 52 through an end face opening, and a head which is set back from the thinner portion, is arranged in the recess 53 and has a smaller axial length than the recess 53, so it can be moved back and forth in the recess 53 between two end positions in the longitudinal direction. The locking pins 54 belong to locks 56, which are arranged on a ring 57, which carries the compressor housing 10. The locks 56 in each case have a lock body 58, which is fastened to the ring 57 and has a radial hole, in which a locking pin 54 is displaceably mounted. Furthermore, the lock bodies 58 contain a spherical block 59 with a spring-loaded ball, which acts in the radial direction on a ramp 60 configured on the locking pin 54. The ramp 60 has an incline such that the pressing force of the ball attempts to move the locking pin 54 radially inwardly in the closing direction or to hold it in the closing position. The locking pin 54 projects radially inwardly from the lock body 58 and its projecting end 61 has a larger diameter than the hole of the lock body 58 and forms an outwardly projecting shoulder, which, in the release position shown in FIG. 4, rests on the lock body 58 and thus limits the release movement of the locking pin 54. On the side facing the ring 57 and the peripheral edge of the compressor housing 10, the inner end of the locking pin 54 is provided with a wedge face.

The piston rods 51 of the pneumatic cylinders 50 project with their outer ends 65 radially outwardly from the pneumatic cylinders 50 and carry a threaded pin 66 screwed into a threaded hole, on which threaded pin a spring plate 67 is adjustably fastened by means of a nut. Compression springs 68, which can be supported, on the one hand, on the pneumatic cylinder 50 and, on the other hand, on the spring plate 67, are arranged on the ends 65. The length of each compression spring 68 and the position of the associated spring plate 67 are matched to one another such that the compression spring 68 is only pressed together if, on coupling the compressor housing 10, the closing path of the locking pin 54 still to be covered to reach the closing position corresponds approximately to half the idle path which the head of the actuating end 55 can cover in the recess 53. The compression springs 68 are therefore shortened when closing the locks 56 only by an amount of length corresponding to half the idle path of the locking pin 54 relative to the piston rod 51. The compression springs 68 compressed in the locking position by an amount corresponding to half the idle path of the locking pin head can then spring back into their pressure-relieved length when the pneumatic cylinders 50 are relieved of actuating pressure and thus move the piston rods 51 back by the corresponding amount.

The coupling mechanism 9 is moved up to the turbocharger cartridge 2 in FIG. 4. The turbocharger cartridge 2 is held here by its flange 62 in the clamping device 5, not shown, of the imbalance measuring device 1. The coupling mechanism 9 is in the open position intended for moving up to the turbocharger cartridge 2. In this position, the pneumatic cylinders 50 are activated such that the locking pins 54 are pulled back into their release position, the actuating ends being loaded with a defined tensile force by the gripping sleeves 52. The ring 57 and the compressor housing 10 fastened thereon are thus held on the holder 47 in the position centered with respect to the rotational axis 48, so the compressor housing 10 on being moved up to the turbocharger cartridge 2 can be pushed with its receiving hole onto a flange 63 of the turbocharger cartridge 2. Once the position shown in FIG. 4 has been reached, the pneumatic cylinders 50 are actuated in the opposing direction and the locking pins 54 are thus moved radially inwardly until they rest rigidly against the flange 63 of the turbocharger cartridge 2 with their wedge faces and thus couple the compressor housing 10 to the turbocharger cartridge 2. The heads of the actuating ends 55 are located here on the radially outer walls of the recesses 53 and are supported radially outwardly on the gripping sleeves 52. The compression springs 68 are tensioned.

The position reached up to now of the coupling mechanism 9 cannot be maintained for a measuring run as the turbocharger cartridge 2 is prevented from oscillating by the pneumatic cylinders 50 located in the locking position. The pneumatic cylinders 50 are therefore controlled in a pressureless manner after the closing of the coupling mechanism 9. Thus, the compression springs 68 arranged on the outer ends 65 of the piston rods 51 can relax, so the piston rods 51 are moved radially outwardly to such an extent that the heads of the actuating ends 55 are located in the recesses 53 in a central position. In this separation position shown in FIG. 7, an adequately large free space is present on either side of the heads and also between the end faces of the gripping sleeves 52 and the locking pins 54 for the oscillations occurring during the process of imbalance measurement, The locking pins 54 are held here by the forces of the spherical blocks and the friction resulting therefrom in the blocking position.

To uncouple the compressor housing 10, the locking pins are moved back into the position shown in FIG. 4 by actuating the pneumatic cylinders 50. The coupling mechanism 9 with the compressor housing 10 held therein is then removed from the turbocharger cartridge 2.

1. Device for the dynamic measurement of the imbalance of a turbo rotor, which has a turbine wheel and a compressor wheel, which are arranged on a shaft which is rotatably mounted in a housing portion, comprising a carrier device, which has at least one spring element, on which the housing portion can be fastened in such a way that it has at least two degrees of freedom for oscillating relative to the carrier device, a turbine housing fastened to the carrier device with a channel, which is configured to supply a drive fluid and for loading the turbo rotor with the drive fluid, a free space being provided between the turbine housing and the housing portion, and at least one measurement sensor for detecting the oscillations of the housing portion, characterized by an automatic coupling mechanism with a movable holder, a connection part which is held ready by the holder and can be moved by the latter up to the housing portion and at least one movable coupling element, by means of which the connection part can be coupled to the housing portion, the coupling mechanism being movable into a position in which the at least one coupling element coupling the connection part to the housing portion can be moved relative to the holder in such a way that the coupled connection part can oscillate unimpeded with the housing portion.

2. Device according to claim 1, characterized in that the connection part is a housing part for covering the compressor wheel.

3. Device according to either of claims 1 or 2, characterized in that the connection part includes a lubricant line.

4. Device according to claim 1, characterized in that a U-shaped spring clip with two mutually opposing legs is provided as the coupling element and can be moved into a clamping position encompassing the housing portion, and by means of which spring clip the connection part can be pressed against the housing portion with a defined force.

5. Device according to claim 4, characterized in that the legs of the spring clip are held on arms of spreading tongs and in that the spreading tongs can be moved by a drive into an open position spreading the legs apart and a closing position coupling the spring clip, it being possible to position the arms in the closing position relative to the legs in such a way that the spring clip can follow oscillations of the housing portion unhindered.

6. Device according to claim 5, characterized in that holding loops are arranged on the arms of the spreading tongs, which loops encompass the legs of the spring clip and have a loop opening, which is greater than the encompassed cross-section of the legs.

7. Device according to any one of claims 4 to 6, characterized in that tubular connection elements, to which feed or discharge lines can be connected, are fastened to the legs of the spring clip.

8. Device according to claim 1, characterized in that at least one lock, arranged on the connection part and having a locking pin, is provided as the coupling element, which locking pin can be moved by a drive arranged on the holder, the drive being separable from the locking pin when the locking pin is located in the clamping position coupling the connection part.

9. Device according to claim 8, characterized in that the locking pin is driven by a pneumatically actuable control cylinder.

10. Device according to either of claims 8 or 9, characterized in that the connection part has a ring, to which a plurality of locks with locking pins oriented toward the centre axis of the ring are fastened at intervals.

11. Device according to either of claims 8 or 9, characterized in that the connection between the locking pin and the pneumatic control cylinder has an idle path in the direction of actuation and the control cylinder can be moved from the locking position by half the idle path into an intermediate position.

12. Device according to claim 10, characterized in that the connection between the locking pin and the pneumatic control cylinder has an idle path in the direction of actuation and the control cylinder can be moved from the locking position by half the idle path into an intermediate position.
